(19) United States
(12) Patent Application Publication
(10) Pub. No.: US 2025/0038795 A1
(43) Pub. Date: Jan. 30, 2025

(54) METHODS AND APPARATUSES FOR TRANSMITTING AND RECEIVING PARAMETER AND COMMUNICATION SYSTEM

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 18/917,347

(22) Filed: Oct. 16, 2024

Related U.S. Application Data
(63) Continuation of application No. PCT/CN2022/087359, filed on Apr. 18, 2022.

(51) Int. Cl. H04B 7/0452

(52) U.S. Cl. CPC H04B 7/0452

(57) ABSTRACT

An apparatus for transmitting parameters, applicable to a terminal equipment, includes: a first receiver configured to receive request information, the request information being used to instruct the terminal equipment to at least transmit parameters of a receive antennas; and a first transmitter configured to transmit the parameters of the receive antennas of the terminal equipment.

### CROSS-REFERENCE TO RELATED APPLICATION

This application is a continuation application of International Application PCT/CN2022/087359 filed on Apr. 18, 2022, and designated the U.S., the entire contents of which are incorporated herein by reference.

### TECHNICAL FIELD

This disclosure relates to the field of communication technologies.

### BACKGROUND

A multiple-input multiple-output (MIMO) technique is one of key techniques of 5G mobile communication. The MIMO is able provide higher channel capacity; however, acquisition of such a benefit depends on whether accurate channel state information is acquired.

In a frequency division duplex (FDD) system, for a downlink, when a network device performs precoding by using information of downlink channels, a terminal equipment needs to feedback downlink channel state information (CSI) to the network device via an uplink. However, due to the information of downlink channels is directly proportional to the number of antennas of the network device, in a scenario of massive MIMO, a huge number of antennas of the network device may lead to a huge overhead for CSI feedback. The Third Generation Partnership Project (3GPP) designs enhanced codebooks (such as etype II codebooks), in which the overhead for CSI feedback is reduced through frequency domain compression. However, for valuable uplink resources, there is still a need to further reduce the overhead for CSI feedback.

With the development of artificial intelligence (AI) technique, applying AI technique to a physical layer of wireless communication to solve difficulties of related methods has become a promising direction. For CSI feedback, downlink channel state information is compressed at a terminal side by an encoder by using a classical encoding and decoding AI model, and the network device receives the compressed channel state information via an air interface and then decompresses it to recover the channel state information. As what is transmitted via the air interface is the compressed channel state information, in a case that channels between different transmitting and receiving antenna ports are correlated, the overhead for CSI feedback may be reduced significantly.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

When a codec compresses and decompresses an M*N dimensional CSI channel matrix (i.e. the number of transmit antenna ports is M, and the number of receive antenna ports is N), both a network device and a terminal equipment need to know the dimensions of the channel matrix. Wherein, the network device knows the number and configuration mode of transmit antenna ports of its own, and the terminal equipment also knows the number and configuration mode of receive antenna ports of its own. In addition, according to 3GPP protocols, the network device notifies the terminal equipment of the number and configuration mode of the transmit antenna ports via signaling.

It was found by the inventors of this disclosure that in the related art, the network device is not aware of parameters of the receive antennas of the terminal equipment, making it difficult to train or select a model for CSI encoding and decoding.

In order to solve the above problems, embodiments of this disclosure provide methods and apparatuses for transmitting and receiving parameters and a communication system, in which a terminal equipment transmits parameters of receive antennas to a network device, hence, the network device is able to train or select a model for CSI encoding and decoding.

According to one aspect of the embodiments of this disclosure, there is provided an apparatus for transmitting parameters, applicable to a terminal equipment, the apparatus including:
a first receiving unit configured to receive request information, the request information being used to instruct the terminal equipment to at least transmit parameters of receive antennas; and
a first transmitting unit configured to transmit the parameters of the receive antennas of the terminal equipment.

According to another aspect of the embodiments of this disclosure, there is provided an apparatus for receiving parameters, applicable to a network device, the apparatus at least including:
a second transmitting unit configured to transmit request information, the request information being used to instruct a terminal equipment to at least transmit parameters of receive antennas; and
a second receiving unit configured to receive the parameters of the receive antennas of the terminal equipment.

An advantage of the embodiments of this disclosure exists in that the terminal equipment transmits the parameters of the receive antennas to the network device, hence, the network device is able to train or select a model for CSI encoding and decoding.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of this disclosure;

FIG. 2 is a schematic diagram of an encoder and a decoder in the communication system of embodiments of this disclosure;

FIG. 3 is a schematic diagram of a method for transmitting parameters of a first aspect of this disclosure;

FIG. 4 is a schematic diagram of a receiving chain in an independent transceiver unit;

FIG. 5 is a schematic diagram of an effective receive antenna;

FIG. 6 is a schematic diagram of an array of the receive antennas;

FIG. 7 is a schematic diagram of a process of performing communication by the communication system of this disclosure based on a method for transmitting parameters of the first aspect;

FIG. 8 is a schematic diagram of a process of performing CSI feedback by the communication system of this disclosure based on the method for transmitting parameters of the first aspect;

FIG. 9 is a schematic diagram of an encoding model using an AI model and a decoding model using the AI model;

FIG. 10 is a schematic diagram of a method for receiving parameters of a second aspect of this disclosure;

FIG. 11 is a schematic diagram of an apparatus for transmitting parameters of a third aspect of this disclosure;

FIG. 12 is a schematic diagram of an apparatus for transmitting parameters of a fourth aspect of this disclosure;

FIG. 13 is a schematic diagram of a terminal equipment of a fifth aspect of this disclosure; and

FIG. 14 is a schematic diagram of a network device of the fifth aspect of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1 G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: an integrated access and backhaul node (IAB node), a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. An uplink signal may include an uplink data signal and/or an uplink control signal, and may also be referred to as uplink transmission (UL transmission) or uplink information or an uplink channel. Transmitting uplink transmission on an uplink resource may be understood as transmitting the uplink transmission by using the uplink resource. Likewise, downlink data/signals/channels/information may be understood accordingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

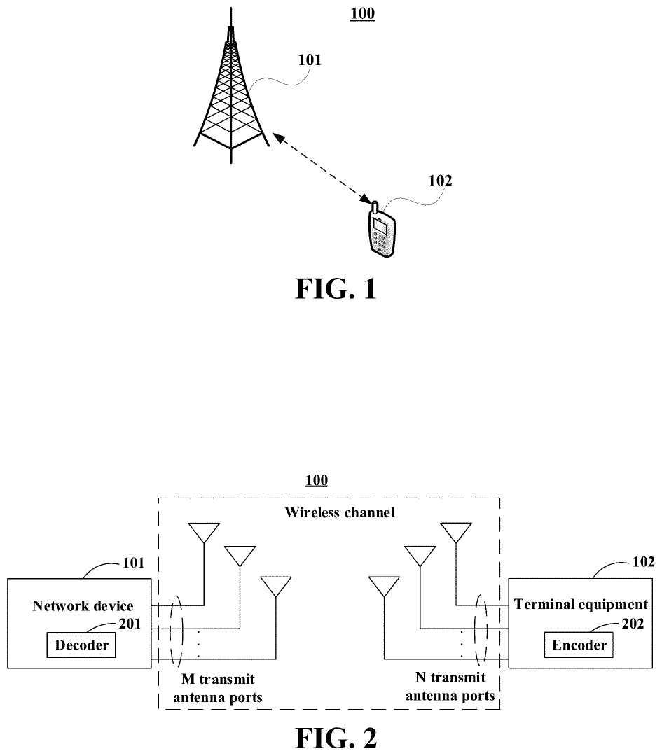

FIG. 1 is a schematic diagram of a communication system of this disclosure, in which a case where a terminal equipment and a network device are taken as an example is schematically shown. As shown in FIG. 1, a communication system 100 may include a network device 101 and a terminal equipment 102 (for the sake of simplicity, an example having only one terminal equipment is schematically given in FIG. 1).

In the embodiments of this disclosure, existing services or services that may be implemented in the future may be performed between the network device 101 and the terminal equipment 102. For example, such services may include but not limited to an enhanced mobile broadband (eMBB), massive machine type communication (MTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

FIG. 2 is a schematic diagram of an encoder and a decoder in a communication system of the embodiments of this disclosure. As shown in FIG. 2, in the communication system 100, the network device 101 may have M transmit antenna ports, and the terminal equipment 102 may have N receive antenna ports. A wireless channel between the network device 101 and the terminal equipment 102 may be represented by an M*N-dimensional channel matrix.

As shown in FIG. 2, a decoder 201 is provided at the network device 101, and an encoder 202 is provided at the terminal equipment 102. The encoder 202 compresses CSI, the terminal equipment 102 transmits the compressed CSI to the network device 101, and the decoder 201 decompresses the received compressed CSI to obtain CSI.

The encoder 202 may perform compression based on an encoding model (e.g. an AI model), and the decoder 201 may perform decompression based on a decoding model (e.g. an AI model).

### Embodiments of a First Aspect

The embodiments of the first aspect provide a method for transmitting parameters, applicable to a terminal equipment, such as the terminal equipment 102 in FIG. 1 or 2.

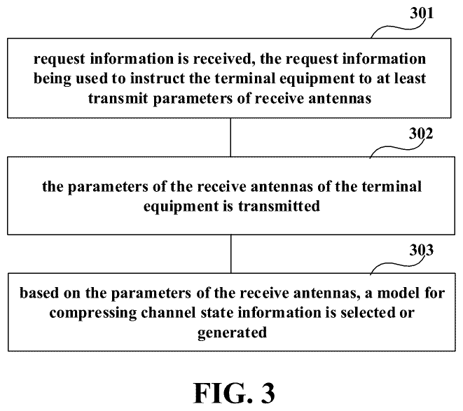

FIG. 3 is a schematic diagram of a method for transmitting parameters of the first aspect of this disclosure. As shown in FIG. 3, the method includes:
operation 301: request information is received, the request information being used to instruct the terminal equipment to at least transmit parameters of receive antennas; and
operation 302: the parameters of the receive antennas of the terminal equipment is transmitted.

In operation 301, the request information is carried in, for example, an AImodelInformEquiry message.

In operation 302, in response to the received request information, the terminal equipment 102 may transmit the parameters of the receive antennas to the network device 101. For example, the parameters of the receive antennas may be carried in an AImodelInformResponse message. In a specific implementation, the terminal equipment 102 may transmit the parameters of the receive antennas via at least one of radio resource control (RRC) signaling or a media access control control element (MAC CE).

In the embodiments of the first aspect, the terminal equipment transmits the parameters of the receive antennas to the network device, hence, the network device may train or select a model for CSI encoding and decoding.

As shown in FIG. 3, the method for transmitting parameters may further at least include:
operation 303: based on the parameters of the receive antennas, a model for compressing channel state information is selected or generated.

In operation 303, the terminal equipment 102 may train an encoding model directly according to the parameters of the receive antennas to generate an encoding model, or may select an appropriate encoding model from trained encoding models. Or, the terminal equipment 102 may train an encoding model according to model information transmitted by the network device 101 to generate an encoding model, or may select an appropriate encoding model from trained encoding models. Thus, the terminal equipment 102 is able to compress the CSI by using an appropriate encoding model.

In at least one embodiment, the parameters of the receive antennas may at least include: the number of ports of the receive antenna, and/or a type of the receive antenna, and/or array configuration of the receive antenna.

A port of the receive antenna is a channel on a symbol on the port, and the channel may be inferred from another symbol on the same port.

In at least one embodiment, the port of the receive antenna may be a receiving chain in an independent transceiver unit.

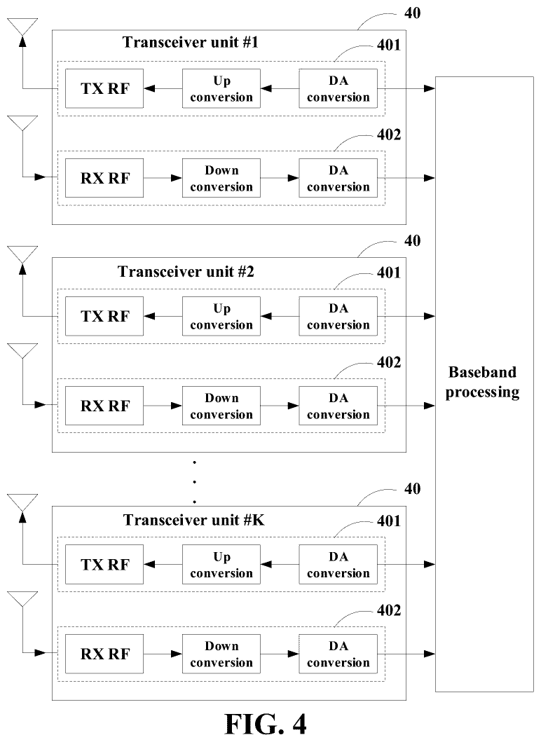

FIG. 4 is a schematic diagram of a receiving chain in an independent transceiver unit. As shown in FIG. 4, in K independent transceiver units 40 of the terminal equipment, each transceiver unit 40 includes a transmitting link 401 and a receiving chain 402, and each receiving chain may correspond to a port of a receive antenna. In FIG. 4, there are K receiving chains 402, and it may be deemed that the number of receiving ports is K.

In addition, the number of transmitting chains 401 and the number of receiving chains 402 in FIG. 4 are equal; however, this disclosure is not limited thereto. For example, in some transceiver units, there may exist no transmitting chains or receiving chains, or in some transceiver units, the transmitting chains or receiving chains may not operate. The number of the receiving ports described in this disclosure may refer to the number of operating receiving chains.

In at least another embodiment, the port of the receive antenna may be an effective receive antenna of multiple receive antenna elements.

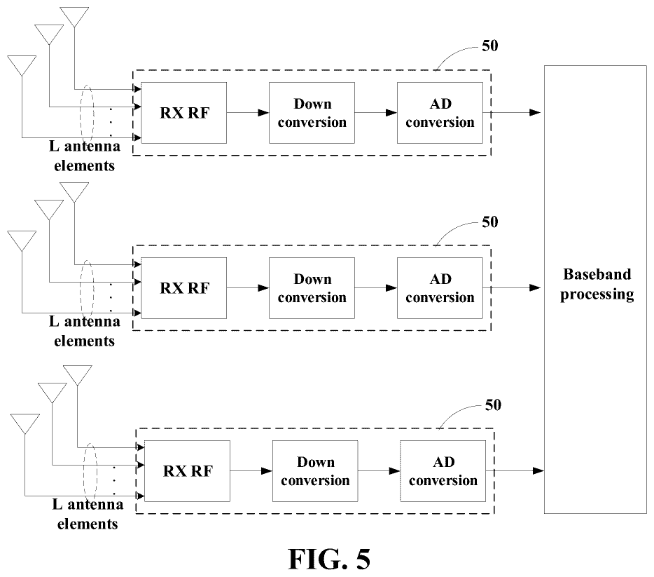

FIG. 5 is a schematic diagram of an effective receive antenna. As shown in FIG. 5, a radio frequency unit 50 may be connected to L receive antenna elements, but the L receive antenna elements correspond to only one receiving chain. Therefore, the L receive antenna elements connected to the same radio frequency unit 50 may be deemed as an effective receive antenna, that is, a port of a receive antenna.

In the embodiments of the first aspect, the type of the receive antenna is at least one of an omnidirectional antenna, a directional antenna or a cross-polarized antenna.

In the embodiments of the first aspect, the array configuration of the receive antenna may include at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.

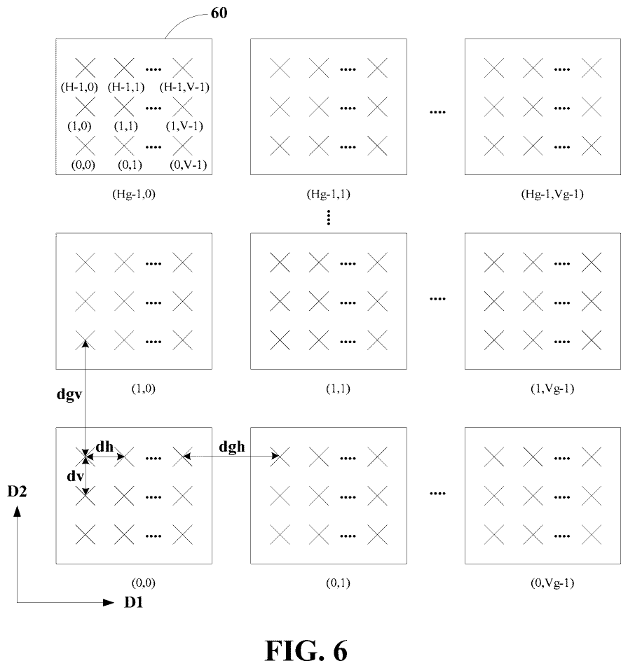

FIG. 6 is a schematic diagram of an array of the receive antennas. As shown in FIG. 6, a first dimension is denoted by D1, a second dimension is denoted by D2, and the first dimension D1 and the second dimension D2 may intersect. For example, the first dimension D1 and the second dimension D2 may be perpendicular to each other. Specifically, the first dimension D1 is a horizontal dimension, and the second dimension D2 is a vertical dimension.

In FIG. 6, there are total Hg*Vg antenna panels 60.

As shown in FIG. 6, Hg denotes the number of antenna panels 60 in the first dimension, Vg denotes the number of antenna panels in the second dimension, H denotes the number of antennas in the first dimension within an antenna panel 60, V denotes the number of antennas in the second dimension within an antenna panel 60, dgh denotes a distance between antenna panels 60 in the first dimension, dgv denotes a distance between antenna panels 60 in the second dimension, Dh denotes a distance between antennas in the first dimension within an antenna panel 60, and dv denotes a distance between antennas in the second dimension within an antenna panel 60.

In at least one embodiment, the array configuration of the receive antenna may a least include two groups of parameters, wherein a first group of parameters may include Hg, Vg, M, N and P, and a second group of parameters may include dgv, dgh, dv and dh.

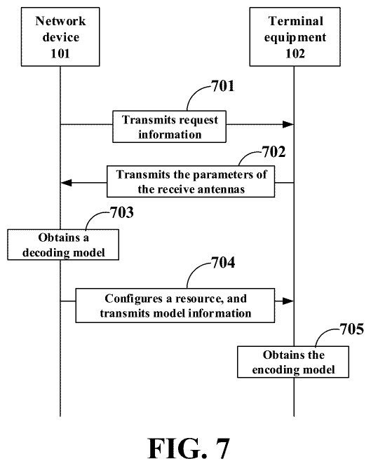

FIG. 7 is a schematic diagram of a process of performing communication by the communication system of this disclosure based on the method for transmitting parameters of the first aspect. As shown in FIG. 7, the process includes:
operation 701: the network device 101 transmits request information to the terminal equipment 102; and
operation 702: the terminal equipment 102 transmits the parameters of the receive antennas of the terminal equipment 102 to the network device 101.

Operations 701 and 702 in FIG. 7 correspond to operations 301 and 302 in FIG. 3, respectively.

As shown in FIG. 7, the process may further at least include:
operation 703: the network device 101 obtains a decoding model based on the received parameters of the receive antennas;
operation 704: the network device 101 configures a resource, and transmits model information related to an encoding model to the terminal equipment 102; and
operation 705: the terminal equipment 102 obtains the encoding model according to the received model information.

In operation 703, network device 101 may train the decoding model according to the parameters of the receive antennas to obtain the decoding model. In addition, network device 101 may also store multiple offline trained decoding models, and select a decoding model according to the parameters of the receive antennas and a correspondence between the receive antenna and the decoding model.

There exists a correspondence between the encoding model and the decoding model. In operation 704, the network device 101 may configure a resource for transmitting the model information, and according to the decoding model determined in operation 703, transmit to the terminal equipment 102 the model information related to the encoding model to which the decoding model corresponds.

Operation 705 may correspond to operation 303. In operation 705, the terminal equipment 102 obtains the encoding model according to the received model information. For example, the model information is a model coefficient of the encoding model. Accordingly, the terminal equipment 102 obtains the encoding model by directly using the model coefficient. For another example, the model information may correspond to the model coefficient, and the terminal equipment 102 may extract a model coefficient corresponding to the model information from multiple groups of model coefficients stored by the terminal equipment 102, and obtain an encoding model according to the extracted model coefficient.

After the terminal equipment 102 and the network device 101 obtain the encoding model and decoding model respectively, the terminal equipment 102 and the network device 101 may perform processing related to feedback of channel state information (such as a channel coefficient matrix).

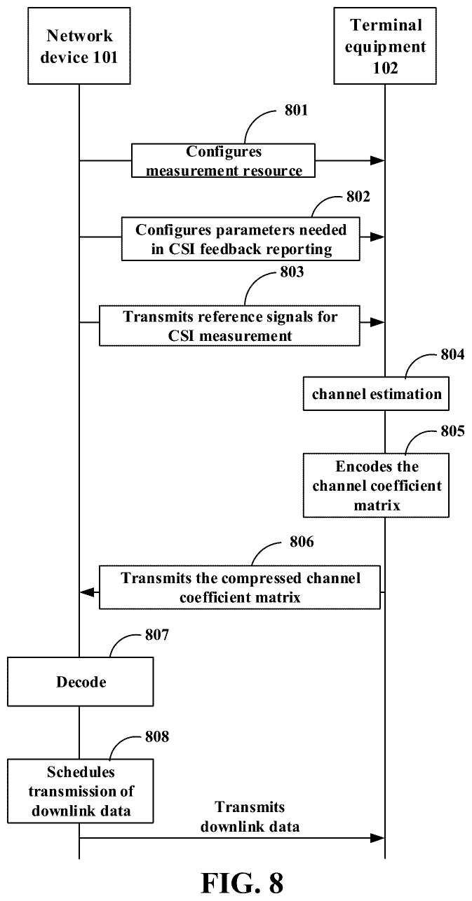

FIG. 8 is a schematic diagram of a process of performing CSI feedback by the communication system of this disclosure based on the method for transmitting parameters of the first aspect.

As shown in FIG. 8, the process includes:
operation 801: the network device 101 configures a measurement resource for measurement of the downlink channel state information via signaling, wherein the signaling is, for example, RRC, an MAC CE, or downlink control information (DCI), and the measurement resource may be a reference signal, such as a CSI-RS, and/or an SSB;
operation 802: the network device 101 configures parameters needed in CSI feedback reporting;
operation 803: the network device 101 transmits reference signals for CSI measurement via a downlink channel;
operation 804: the terminal equipment 102 performs channel estimation after receiving the reference signals for CSI measurement, so as to obtain a channel coefficient matrix of a wireless channel;
operation 805: the terminal equipment 102 feeds the channel coefficient matrix to the encoder, and the encoder compresses the channel coefficient matrix based on the encoding model;
operation 806: the terminal equipment 102 transmits the compressed channel coefficient matrix on corresponding time-frequency resource according to configuration in the CSI feedback reporting;
operation 807: the network device 101 feeds the compressed channel coefficient matrix to the decoder after receiving the compressed channel coefficient matrix, and the decoder performs decompression based on the decoding model, to recover an original channel coefficient matrix; and
operation 808: the network device 101 schedules transmission of downlink data according to the recovered original channel coefficient matrix.

The process in FIG. 8 describes a method for performing downlink channel CSI (e.g. a channel state matrix) feedback by using a codec. With the compression by the encoder, amount of feedback of channel state information may be significantly reduced in a case flat fading channels.

In the embodiments of the first aspect, the encoding model may adopt an AI model, and the decoding model may also adopt an AI model.

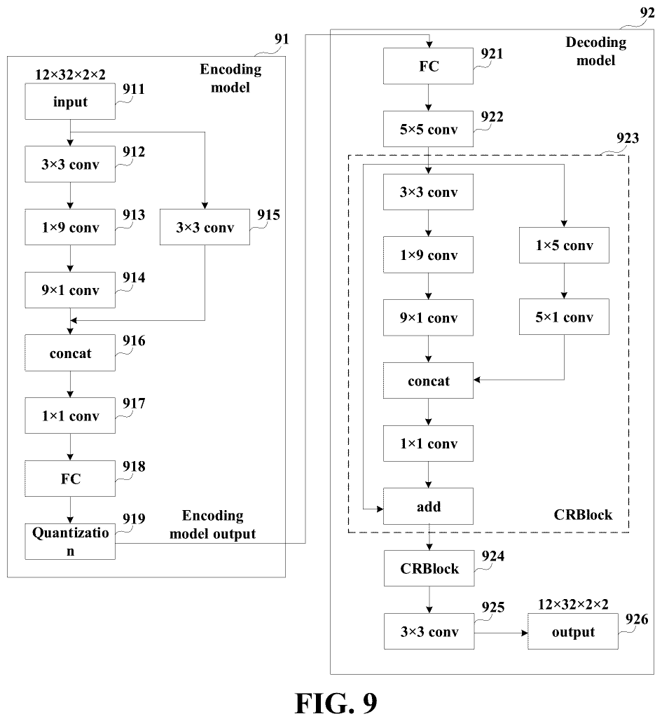

FIG. 9 is a schematic diagram of an encoding model using an AI model and a decoding model using the AI model.

As shown in FIG. 9, the encoding model 91 for CSI compression is applied to the terminal equipment, and the decoding model 92 for decompression is applied to the network device. Assuming that the number of transmit antenna ports of the network device is 32, the number of receive antenna ports of the terminal equipment is 2, a bandwidth of the communication system is 24 resource blocks (RBs), and a density of a channel state information reference signal (CSI-RS) in the frequency domain is 0.5, i.e. there exists one CSI-RS signal on 2 RBs, there are total 12 CSI-RSs in the frequency domain. A dimension of data input onto the encoding model 91 is 12×32×2×2 (i.e. the number of RSs in the frequency domain×the number of transmit antenna ports of the network device×the number of receive antenna ports of the terminal equipment×I/Q paths).

As shown in FIG. 9, the encoding model 91 includes: an input layer (input) 911, a 3×3 convolution layer (3×3 conv) 912, a 1×9 convolution layer (1×9 conv) 913, a 9×1 convolution layer (9×1 conv) 914, a 3×3 convolution layer (3×3 conv) 915, a connection layer (concat) 916, a 1×1 convolution layer (1×1 conv) 917, a full connection layer (FC) 918, and a quantizer 919, where processing results of the 9×1 convolution layer (9×1 conv) 914 and the 3×3 convolution layer (3×3 conv) 915 are merged in the connection layer 916.

The encoding model 91 outputs compressed channel state information, and the compressed channel state information is transmitted to the network device over an air interface.

As shown in FIG. 9, the decoding model 92 includes a full connection layer (FC) 921, a 5×5 convolution layer (5×5 cov) 922, a first channel reconstruction block (CRBlock) 923, a second channel reconstruction block (CRBlock) 924, a 3×3 convolution layer (3×3 cov) 925, and an output layer (output) 926.

As shown in FIG. 9, the first channel reconstruction block 923 and the second channel reconstruction block 924 may have identical structures. For example, the first channel reconstruction block 923 may include: two parallel branches, one of which including a 3×3 convolution layer (3×3 cov), a 1×9 convolution layer (1×9 cov) and a 9×1 convolution layer (9×1 cov), and the other one including a 1×5 convolution layer (1×5 cov) and a 5×1 convolution layer (5×1 cov); a connection layer (Concat) used to merge results of the two branches; a 1×1 convolution layer (1×1 cov); and an addition (add) processing layer used to add up an output of the 1×1 convolution layer (1×1 cov) and an output of the 5×5 convolution layer (5×5 cov).

As shown in FIG. 9, the data output by the output layer 926 are the decompressed channel state information, and a data dimension thereof is 12×32×2×2, which is consistent with a dimension of the input data of encoding model 91.

It should be noted that the above description of the encoding model 91 and the decoding model 92 is illustrative only, and as the information of the transmit antenna and the receive antenna changes, the parameters of the layers in the encoding model 91 and the decoding model 92 may possibly change, and structures of the encoding model 91 and the decoding model 92 may also change.

According to the embodiments of the first aspect of this disclosure, the terminal equipment transmits the parameters of the receive antennas to the network device, hence, the network device is able to train or select a model for CSI encoding and decoding, and the terminal equipment may obtain an appropriate model.

### Embodiments of a Second Aspect

At least addressed to the same issues as the embodiments of the first aspect, the embodiments of the second aspect of this disclosure provide a method for receiving parameters, applicable to a network device. The method for receiving parameters in the second aspect corresponds to the method for transmitting parameters in the embodiments of the first aspect.

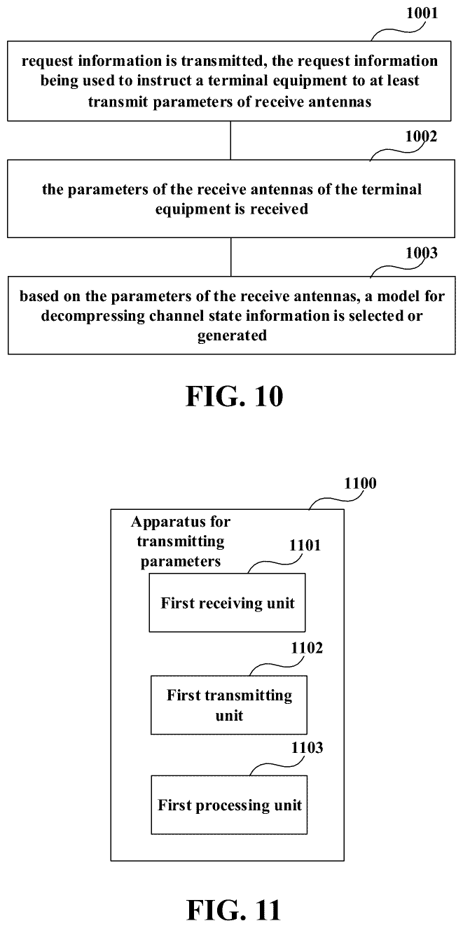

FIG. 10 is a schematic diagram of a method for receiving parameters of the embodiments of the second aspect of this disclosure. As shown in FIG. 10, the method for receiving parameters at least includes:
operation 1001: request information is transmitted, the request information being used to instruct a terminal equipment to at least transmit parameters of receive antennas; and
operation 1002: the parameters of the receive antennas of the terminal equipment is received.

In operation 1002, the network device 101 may receive the parameters of the receive antennas via at least one of radio resource control (RRC) signaling or a media access control control element (MAC CE).

As shown in FIG. 10, the method for receiving parameters further include:
operation 1003: based on the parameters of the receive antennas, a model for decompressing channel state information is selected or generated.

In at least one embodiment, the parameters of the receive antennas at least includes: the number of ports of the receive antenna, and/or a type of the receive antenna, and/or array configuration of the receive antenna.

A port of the receive antenna may be a channel on a symbol on the port, the channel being able to be inferred from another symbol on the same port; or, the port of the receive antenna is a receiving chain in an independent transceiver unit; or, the port of the receive antenna is an effective receive antenna in multiple receive antenna elements.

The type of the receive antenna is at least one of an omnidirectional antenna, a directional antenna or a cross-polarized antenna.

The array configuration of the receive antenna includes at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.

According to the embodiments of the second aspect of this disclosure, the network device receives the parameters of the receive antennas transmitted by the terminal equipment, hence, the network device is able to train or select a model for CSI encoding and decoding, and the terminal equipment may obtain an appropriate model, thereby facilitating encoding and decoding the CSI.

### Embodiments of a Third Aspect

The embodiments of the third aspect of this disclosure provide an apparatus for transmitting parameters, which is applicable to a terminal equipment, and corresponds to the method for transmitting parameters in the embodiments of the first aspect.

FIG. 11 is a schematic diagram of the apparatus for transmitting parameters of the third aspect of this disclosure. As shown in FIG. 11, an apparatus 1100 for transmitting parameters includes a first receiving unit 1101 and a first transmitting unit 1102.

The first receiving unit 1101 receives request information, the request information being used to instruct the terminal equipment to at least transmit parameters of a receive antennas; and the first transmitting unit 1102 transmits the parameters of the receive antennas of the terminal equipment.

The parameters of the receive antennas are transmitted via at least one of radio resource control (RRC) signaling or a media access control control element (MAC CE).

As shown in FIG. 11, the apparatus 1100 further includes:
a first processing unit 1103 configured to, based on the parameters of the receive antennas, select or generate a model for compressing channel state information.

In at least one embodiment, the parameters of the receive antennas at least includes: the number of ports of the receive antenna, and/or a type of the receive antenna, and/or array configuration of the receive antenna.

A port of the receive antenna is a channel on a symbol on the port, the channel being able to be inferred from another symbol on the same port; or, the port of the receive antenna is a receiving chain in an independent transceiver unit; or, the port of the receive antenna is an effective receive antenna in multiple receive antenna elements.

In at least one embodiment, the type of the receive antenna is at least one of an omnidirectional antenna, a directional antenna or a cross-polarized antenna.

The array configuration of the receive antenna includes at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.

According to the embodiments of the third aspect of this disclosure, the terminal equipment transmits the parameters of the receive antennas to the network device, hence, the network device is able to train or select a model for CSI encoding and decoding, and the terminal equipment may obtain an appropriate model, thereby facilitating encoding and decoding the CSI.

### Embodiments of a Fourth Aspect

The embodiments of the fourth aspect of this disclosure provide an apparatus for receiving parameters, which is applicable to a network device, and corresponds to the method for receiving parameters in the embodiments of the second aspect.

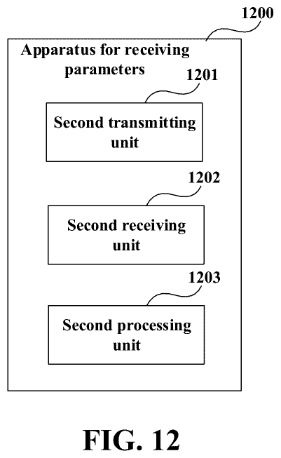

FIG. 12 is a schematic diagram of an apparatus for transmitting parameters of the fourth aspect of this disclosure. As shown in FIG. 12, an apparatus 1200 for transmitting parameters includes a second transmitting unit 1201 and a second receiving unit 1202.

The second transmitting unit 1201 transmits request information, the request information being used to instruct a terminal equipment to at least transmit parameters of a receive antennas; and the second receiving unit 1202 receives the parameters of the receive antennas of the terminal equipment.

The parameters of the receive antennas are transmitted via at least one of radio resource control (RRC) signaling or a media access control control element (MAC CE).

As shown in FIG. 12, the apparatus 1200 further includes:
a second processing unit 1203 configured to, based on the parameters of the receive antennas, select or generate a model for decompressing channel state information.

In at least one embodiment, the parameters of the receive antennas at least includes: the number of ports of the receive antenna, and/or a type of the receive antenna, and/or array configuration of the receive antenna.

A port of the receive antenna is a channel on a symbol on the port, the channel being able to be inferred from another symbol on the same port; or, the port of the receive antenna is a receiving chain in an independent transceiver unit; or, the port of the receive antenna is an effective receive antenna in multiple receive antenna elements.

In at least one embodiment, the type of the receive antenna is at least one of an omnidirectional antenna, a directional antenna or a cross-polarized antenna.

The array configuration of the receive antenna includes at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.

According to the embodiments of the fourth aspect of this disclosure, the network device receives the parameters of the receive antennas transmitted by the terminal equipment, hence, the network device is able to train or select a model for CSI encoding and decoding, and the terminal equipment may obtain an appropriate model, thereby facilitating encoding and decoding the CSI.

### Embodiments of a Fifth Aspect

The embodiments of this disclosure provide a communication system, including a network device and a terminal equipment.

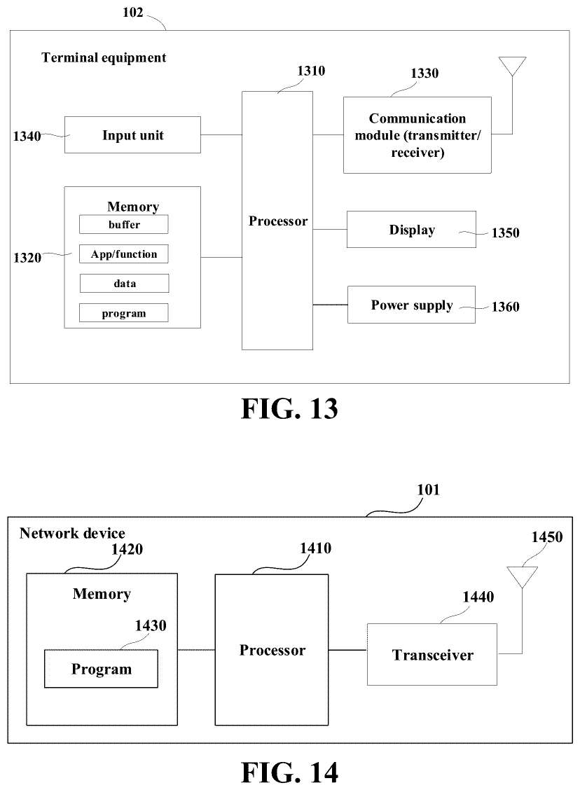

FIG. 13 is a schematic diagram of a terminal equipment of the fifth aspect of this disclosure. As shown in FIG. 13, a terminal equipment 102 may include a processor 1310 and a memory 1320, the memory 1320 storing data and a program and being coupled to the processor 1310. It should be noted that this figure is illustrative only, and other types of structures may also be used, so as to supplement or replace this structure and achieve a telecommunications function or other functions.

For example, the processor 1310 may be configured to execute a program to carry out the methods as described in the embodiments of the first aspect.

As shown in FIG. 13, the terminal equipment 102 may further include a communication module 1330, an input unit 1340, a display 1350, and a power supply 1360, wherein functions of the above components are similar to those in the related art, which shall not be described herein any further. It should be noted that the terminal equipment 102 does not necessarily include all the parts shown in FIG. 13, and the above components are not necessary. Furthermore, the terminal equipment 102 may include parts not shown in FIG. 13, and the related art may be referred to.

FIG. 14 is a schematic diagram of a network device of the fifth aspect of this disclosure. As shown in FIG. 14, a network device 101 may include a processor 1410 (such as a central processing unit (CPU)) and a memory 1420, the memory 1420 being coupled to the processor 1410. Wherein, the memory 1420 may store various data, and furthermore, it may store a program 1430 for information processing, and execute the program 1430 under control of the processor 1410.

For example, the processor 1410 may be configured to execute a program to carry out the method described in the embodiments of the second aspect.

Furthermore, as shown in FIG. 14, the network device 101 may include a transceiver 1440, and an antenna 1450, etc. Functions of the above components are similar to those in the related art, and shall not be described herein any further. It should be noted that the network device 101 does not necessarily include all the parts shown in FIG. 14, and furthermore, the network device 101 may include parts not shown in FIG. 14, and the related art may be referred to.

Embodiments of this disclosure provide a computer readable program, which, when executed in a terminal equipment, causes the terminal equipment to carry out the method as described in the embodiments of the first aspect.

Embodiments of this disclosure provide a computer storage medium, including a computer readable program, which causes a terminal equipment to carry out the method as described in the embodiments of the first aspect.

Embodiments of this disclosure provide a computer readable program, which, when executed in a network device, causes the network device to carry out the method as described in the embodiments of the second aspect.

Embodiments of this disclosure provide a computer storage medium, including a computer readable program, which causes a network device to carry out the method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.
1. A method for transmitting parameters, applicable to a terminal equipment, the method including:
receiving request information, the request information being used to instruct the terminal equipment to at least transmit parameters of receive antennas; and
transmitting the parameters of the receive antennas of the terminal equipment.
2. The method according to supplement 1, wherein, the parameters of the receive antennas at least include:
the number of ports of the receive antenna, and/or a type of the receive antenna, and/or array configuration of the receive antenna.
3. The method according to supplement 2, wherein,
a port of the receive antenna is a channel on a symbol on the port, the channel being able to be inferred from another symbol on the same port; or
a port of the receive antenna is a receiving chain in an independent transceiver unit; or
a port of the receive antenna is an effective receive antenna in multiple receive antenna elements.
4. The method according to supplement 2, wherein,
the type of the receive antenna is at least one of an omnidirectional antenna, a directional antenna or a cross-polarized antenna.
5. The method according to supplement 2, wherein,
the array configuration of the receive antenna includes at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.
6. The method according to supplement 1, wherein,
the parameters of the receive antennas are transmitted via at least one of radio resource control (RRC) signaling or a media access control control element (MAC CE).
7. The method according to supplement 1, wherein,
the method further includes:
based on the parameters of the receive antennas, selecting or generating a model for compressing channel state information.
8. A method for receiving parameters, applicable to a network device, the method including:
transmitting request information, the request information being used to instruct a terminal equipment to at least transmit parameters of receive antennas; and
receiving the parameters of the receive antennas of the terminal equipment.
9. The method according to supplement 8, wherein,
the parameters of the receive antennas at least include:
the number of ports of the receive antenna, and/or a type of the receive antenna, and/or array configuration of the receive antenna.
10. The method according to supplement 9, wherein,
a port of the receive antenna is a channel on a symbol on the port, the channel being able to be inferred from another symbol on the same port; or
a port of the receive antenna is a receiving chain in an independent transceiver unit; or
a port of the receive antenna is an effective receive antenna in multiple receive antenna elements.
11. The method according to supplement 9, wherein,
the type of the receive antenna is at least one of an omnidirectional antenna, a directional antenna or a cross-polarized antenna.
12. The method according to supplement 9, wherein,
the array configuration of the receive antenna includes at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.
13. The method according to supplement 8, wherein,
the parameters of the receive antennas are transmitted via at least one of radio resource control (RRC) signaling or a media access control control element (MAC CE).
14. The method according to supplement 8, wherein,
the method further includes:
based on the parameters of the receive antennas, selecting or generating a model for decompressing channel state information.

What is claimed is:

1. An apparatus for transmitting parameters, applicable to a terminal equipment, the apparatus comprising:
a first receiver configured to receive request information, the request information being used to instruct the terminal equipment to at least transmit parameters of a receive antennas; and
a first transmitter configured to transmit the parameters of the receive antennas of the terminal equipment.

2. The apparatus according to claim 1, wherein,
the parameters of the receive antennas at least comprise:
the number of ports of the receive antenna, and/or a type of the receive antenna, and/or array configuration of the receive antenna.

3. The apparatus according to claim 2, wherein,
a port of the receive antenna is a channel on a symbol on the port, the channel being able to be inferred from another symbol on the same port; or
a port of the receive antenna is a receiving chain in an independent transceiver; or
a port of the receive antenna is an effective receive antenna in multiple receive antenna elements.

4. The apparatus according to claim 2, wherein,
the type of the receive antennas is at least one of an omnidirectional antenna, a directional antenna or a cross-polarized antenna.

5. The apparatus according to claim 2, wherein,
the array configuration of the receive antenna comprises at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.

6. The apparatus according to claim 1, wherein,
the parameters of the receive antennas are transmitted via at least one of radio resource control (RRC) signaling or a media access control control element (MAC CE).

7. The apparatus according to claim 1,
the apparatus further comprising:
first processor circuitry configured to, based on the parameters of the receive antennas, select or generate a model for compressing channel state information.

8. An apparatus for receiving parameters, applicable to a network device, the apparatus comprising:
a second transmitter configured to transmit request information, the request information being used to instruct a terminal equipment to at least transmit parameters of receive antennas; and
a second receiver configured to receive the parameters of the receive antennas of the terminal equipment.

9. The apparatus according to claim 8, wherein,
the parameters of the receive antennas at least comprise:
the number of ports of the receive antenna, and/or a type of the receive antenna, and/or array configuration of the receive antenna.

10. The apparatus according to claim 9, wherein,
a port of the receive antenna is a channel on a symbol on the port, the channel being able to be inferred from another symbol on the same port; or
a port of the receive antenna is a receiving chain in an independent transceiver; or
a port of the receive antenna is an effective receive antenna in multiple receive antenna elements.

11. The apparatus according to claim 9, wherein,
the type of the receive antenna is at least one of an omnidirectional antenna, a directional antenna or a cross-polarized antenna.

12. The apparatus according to claim 9, wherein,
the array configuration of the receive antenna comprises at least one of the following parameters:
the number of antenna panels in a first dimension and/or the number of antenna panels in a second dimension;
the number of antennas in the first dimension and/or the number of antennas in the second dimension in an antenna panel;
a polarization direction of an antenna;
a distance between antenna panels in the first dimension and/or a distance between antenna panels in the second dimension; or
a distance between antennas in the first dimension and/or in the second dimension in an antenna panel.

13. The apparatus according to claim 8, wherein,
the parameters of the receive antennas are transmitted via at least one of radio resource control (RRC) signaling or a media access control control element (MAC CE).

14. The apparatus according to claim 8,
the apparatus further comprising:
second processor circuitry configured to, based on the parameters of the receive antennas, select or generate a model for decompressing channel state information.

15. A communication system, comprising:
a terminal equipment comprising an apparatus for transmitting parameters, the apparatus comprising:
a first receiver configured to receive request information, the request information being used to instruct the terminal equipment to at least transmit parameters of a receive antennas; and
a first transmitter configured to transmit the parameters of the receive antennas of the terminal equipment; and
a network device comprising an apparatus for receiving parameters, the apparatus comprising:
a second transmitter configured to transmit request information, the request information being used to instruct a terminal equipment to at least transmit parameters of receive antennas; and
a second receiver configured to receive the parameters of the receive antennas of the terminal equipment.
